(19) United States
(12) Patent Application Publication
(10) Pub. No.: US 2008/0289604 A1
(43) Pub. Date: Nov. 27, 2008

(54) Method and System for Controlling Engine Noise

(76) Inventor: Abraham Joseph, Maharashtra (IN)

Correspondence Address: NATH & ASSOCIATES, 112 South West Street, Alexandria, VA, 22314, US

(21) Appl. No.: 11/988,043

(22) PCT Filed: Jun. 30, 2006
(86) PCT No.: PCT/IN2006/000227

§ 371 Date: Dec. 28, 2007

(51) Int. Cl. F02P 5/145

(52) U.S. Cl. 123/406.51

(57) ABSTRACT

The present invention provides a method of controlling noise and harshness caused by combustion in a spark ignited engine having a combustion chamber; a fuel delivery means for delivering a fuel charge to the combustion chamber; a plurality of spark ignition means located in the combustion chamber for igniting the fuel charge and a control unit. The control unit controls operation of each ignition means in response to measured value of at least one combustion noise associated parameter, being an engine operating condition. Control may be a response to the combustion noise associated parameter breaching a threshold value. The combustion noise associated parameter may be rate of rise of combustion pressure in the combustion chamber. However, the method may be implemented in response to rate of rise of combustion pressure and one or more further parameters, such as engine speed, acceleration and/or engine load breaching threshold values. An ignition control system for implementing the method in a vehicle forms another aspect of the invention. The method and ignition control system may be implemented in fuel injected engines or carbureted engines but is particularly advantageous for fuel injected engines.

This invention relates to a method and system for controlling engine noise, particularly noise associated with combustion.

The Applicant has invented an engine having a plurality of ignition means for each combustion chamber. Such a small bore or small displacement engine, as described in the Applicant's granted Indian Patent 195905 dated Jul. 16, 2002, the contents of which are hereby incorporated herein by reference, allows efficient burning of lean air-fuel mixtures. Particularly applicable to small displacement engines, the plural or dual ignition means arrangement allows two spark plugs to be energized simultaneously at a predetermined instant below top dead centre to burn a lean air-fuel mixture in an efficient manner. Such vehicles have been well received but the Applicant wished to improve noise levels which, while within statutory limits, were slightly high.

It appears that simultaneous energizing of spark plugs may lead to uncomfortable noise levels or sound harshness when an engine is rapidly accelerated or operated in higher speed engine operating regimes. This noise is to be distinguished from noise generated as a result of the well known “knock” phenomenon in that it does not necessarily cause mechanical damage to the engine.

When a vehicle employing the engine is cruising at a constant speed, say between 15 to 60 kin/h, an engine may burn a lean fuel-air mixture at a quick enough rate to achieve efficient combustion without uncomfortable noise and sound harshness. In such condition, the rate of rise of combustion pressure is good enough to achieve efficient combustion. However, when the engine is accelerated rapidly, the cylinder instantaneously fills with a greater amount of air-fuel mixture which is compressed to higher pressures leading to a higher rate of rise of combustion pressure. At this instant, in known engines, dual spark plug ignition causes the rate of rise of combustion pressure to increase further, leading to uncomfortable noise levels and harshness of sound. Such a rapid rise in combustion pressure also leads to rapid acceleration of the moving parts taking up the clearances between them rapidly during a piston stroke. This increases the noise and harshness problem. It has been observed that if the rate of rise of combustion pressure is more than a threshold value, about 3.5 bar per degree of crank rotation, it leads to uncomfortable noise levels or harshness of sound.

It has also been observed that, when the engine runs at a higher engine speed, say greater than 6000 rpm, uncomfortable noise levels or harshness of sound is produced. At these speeds, the higher flow velocity of the air fuel mixture creates turbulence in the engine cylinder. The air fuel ratio is also richer to take care of the durability of engine components. These factors ie: turbulence in the cylinder and the higher amount of richer charge leads to a higher rate of rise of combustion pressure in known engines due to dual spark plug ignition thus causing uncomfortable noise levels or harshness of sound.

It is an object of the present invention to address the problem of combustion associated noise and harshness in engines having combustion chambers fitted with a plurality of spark ignition means.

With this object in view, the present invention provides a method of controlling noise and harshness caused by combustion in a spark ignited engine having a combustion chamber; a fuel delivery means for delivering a fuel charge to the combustion chamber; a plurality of spark ignition means located in the combustion chamber for igniting the fuel charge and a control unit wherein said control unit controls operation of each ignition means of said plurality of ignition means in response to measured value of a combustion noise associated parameter. Such control may be implemented in response to the measured value of the combustion noise associated parameter breaching a predetermined threshold level.

Preferably, the fuel delivery means is a fuel injector located in a manifold for the engine. The fuel delivery means may comprise a carburetor.

Preferably, the fuel charge is a mixture of air and fuel. The fuel charge may have an air fuel ratio in the lean range or the rich range. Dual spark ignition may be avoided when air fuel ratio is in the rich range.

The combustion noise associated parameter may be selected from a suite of possible engine operating conditions. The rate of rise of combustion pressure in a combustion chamber is strongly associated with combustion noise and harshness as above described and is the preferred or primary parameter for control. Indeed, the method may be implemented to maintain rate of rise of combustion pressure below a predetermined threshold value at which noise levels are acceptable. The rate of rise of combustion pressure may be expressed as pressure rise per degree of crank rotation and, accordingly, the predetermined threshold may be 3.5 bar per degree of crank rotation. The rate of rise of combustion pressure may also be expressed as pressure rise per unit time.

Rise in combustion pressure has associated parameters such as speed, acceleration, engine load, throttle position, air fuel ratio and manifold vacuum pressure or variation in these each of which are secondary noise associated parameters that may be sensed or measured for a given plural, likely dual, ignition means engine and used as a control parameter in combination with rate of rise of combustion pressure or possibly alone, particularly at high engine speeds, for example greater than 5000 rpm. Advantageously, control over ignition means and combustion proceeds on the basis of measured rate of rise of combustion pressure and at least one other parameter, particularly engine speed or acceleration, breaching predetermined threshold values particularly under mid engine speed conditions, for example 1600 to 5000 rpm.

In another aspect, the invention provides an ignition control system for a vehicle comprising:

a plurality of spark ignition means; and

a control unit for controlling operation of each ignition means wherein said control unit is programmed to receive combustion noise associated parameter data and operate each ignition means in accordance with said combustion noise associated parameter data.

The method and system are particularly applicable to the situation in which the engine is in a load transition, usually from part load to full load. The nature of ignition means timing control in accordance with the method may be varied dependent on engine load conditions.

Sensing of engine speed and acceleration provides a convenient way to provide data to the control unit. The control unit, which may be a micro-controller, may then operate the ignition means to control the noise level through control over firing time for one or both ignition means. Firing of an ignition means may be discontinued, if necessary, to achieve desired noise control. Retarding of the firing timing of one ignition means relative to firing timing of another ignition means is a preferred. mode of control as well. Such retard may vary as a function of engine operating conditions.

Under “normal” conditions, where noise is unlikely to be problematic, both ignition means or spark plugs may be fired at the same time, especially if combustion of lean mixtures is required, though the spark plugs could be fired at some fixed offset in timing. If engine speed and/or acceleration, for example, exceed a predetermined value, the control unit may retard or delay energizing the firing event of one of the spark ignition means or spark plugs. Under such conditions, even a lean mixture may not require promotion of ignition by plural ignition means.

If engine speed and/or acceleration is below the predetermined value, for example 1600 rpm for engine speed, the spark plugs may be energized simultaneously with the emphasis on engine power output. The control unit may implement such steps in response to combustion noise associated parameter data other than engine speed and acceleration data. The control unit may be programmed with maps of ignition firing time/ignition means discontinuation for various engine operating conditions, for example engine speed. Such maps may correspond with part open throttle or wide open throttle conditions.

Further, control over operation of the ignition means, for example in terms of retarding the firing event or timing of one of the spark plugs, relative to the firing event or timing of another spark plug may occur in response to a noise prone combination of measured or sensed combustion noise associated parameter data. For example, delay over the timing of the firing event may occur in response to both rate of rise of combustion pressure and engine speed or acceleration being above threshold values for the implementation of control.

The ignition timing for the spark plugs may be retarded in stepwise manner under operating conditions when noise control is required. This requires less capacity for the control unit. However, a smoothed transition of ignition firing event timing may be preferred, the degree of retardation being determined as a function of the selected combustion noise associated control parameter. The degree of retardation of firing or suspension of firing of one of the spark plugs may be determined from ignition timing/engine speed maps which may correspond with part open throttle or wide open throttle conditions. Maps using combustion noise associated parameters other than engine speed may also be employed.

The engine controlled in accordance with the method or implementing the ignition control system aspects of the invention may be a carburetted engine, a manifold injected engine or a direct injected engine. Use of the method and control system in relation to a fuel injected engine is a particularly advantageous embodiment of the invention. The engine may be a two stroke or four stroke engine and may particularly advantageously be applied to a small bore or small displacement engine.

In a further aspect, the present invention provides a method of controlling noise and harshness in an engine having a cylinder provided with a plurality of ignition means comprising, during operation of an engine in transition from part load to full load:

a) measuring rate of rise of combustion pressure in said cylinder; and

b) retarding energising or firing of an ignition means in said cylinder by controlled degree if measured rate of rise of combustion pressure exceeds a predetermined value; wherein degree of retardation of firing of said ignition means is controlled dependent on sensed engine speed and load conditions.

The present invention will now be described in detail with reference to non limiting preferred embodiments as illustrated in the accompanying drawings, wherein;

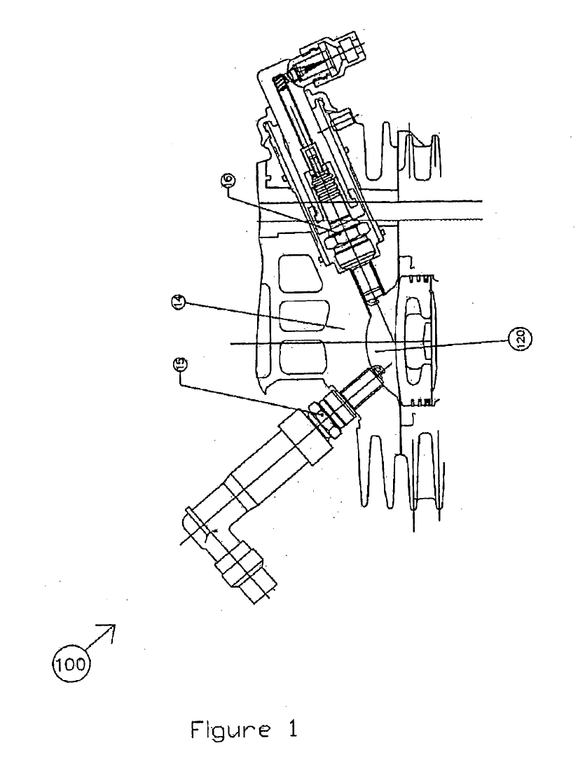

FIG. 1 illustrates a section of a cylinder head of a dual ignition means engine.

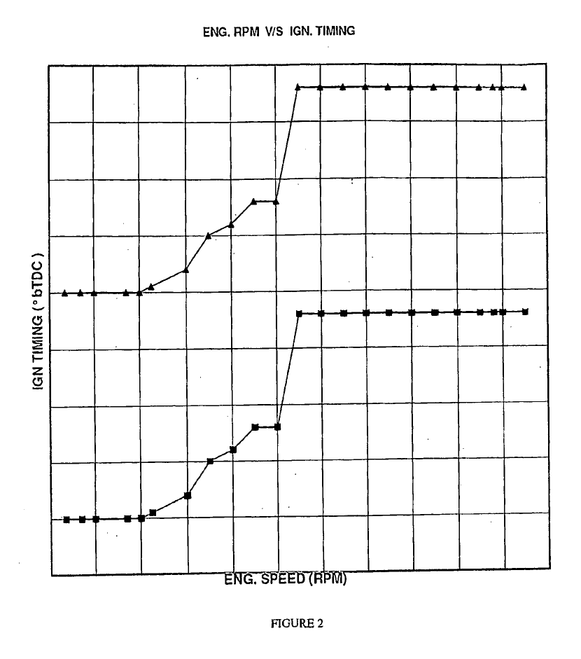

FIG. 2 illustrates ignition timing curves of an engine ignition system according to the present invention,

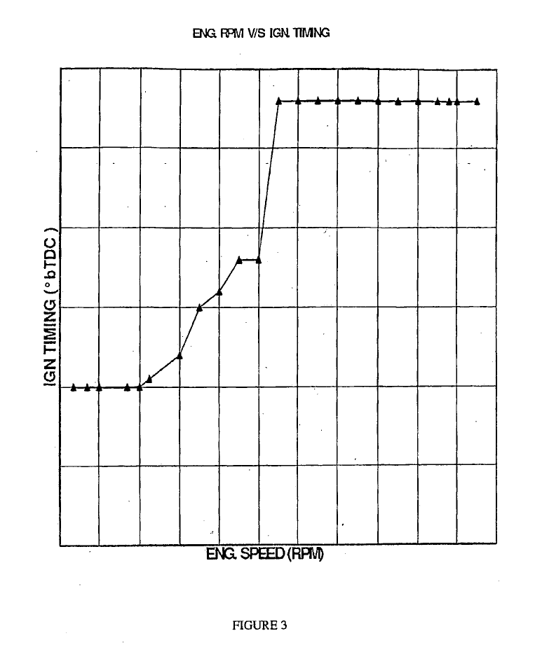

FIG. 3 illustrates ignition timing curves of an engine ignition system according to the prior art.

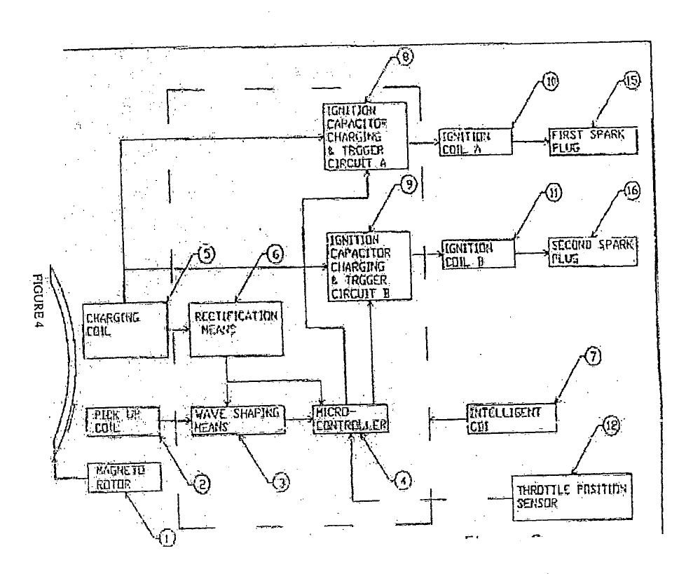

FIG. 4 illustrates a block diagram of one embodiment of ignition system according to the present invention.

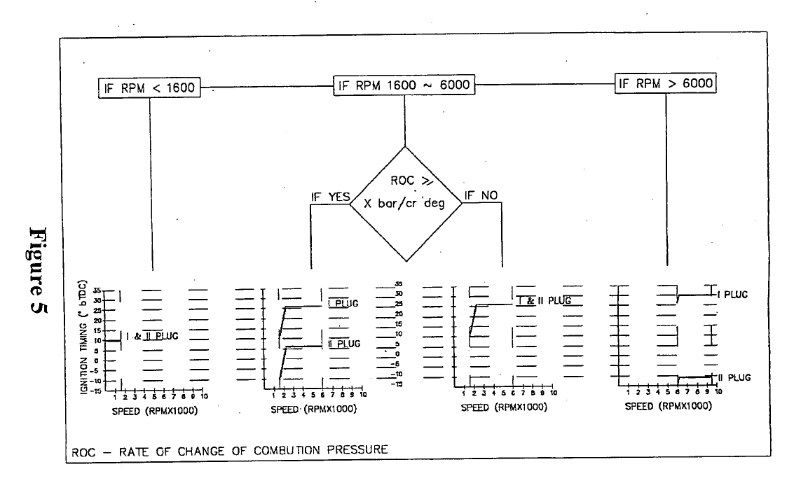

FIG. 5 illustrates a flowchart for operation of the ignition system according to one embodiment of the present invention under Part Open Throttle Conditions.

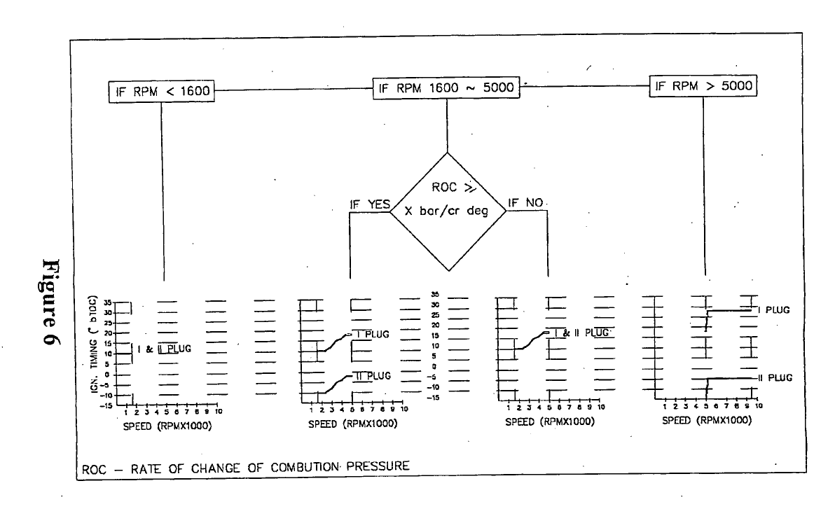

FIG. 6 illustrates a flowchart for operation of the ignition system according to one embodiment of the present invention under Wide Open Throttle Conditions.

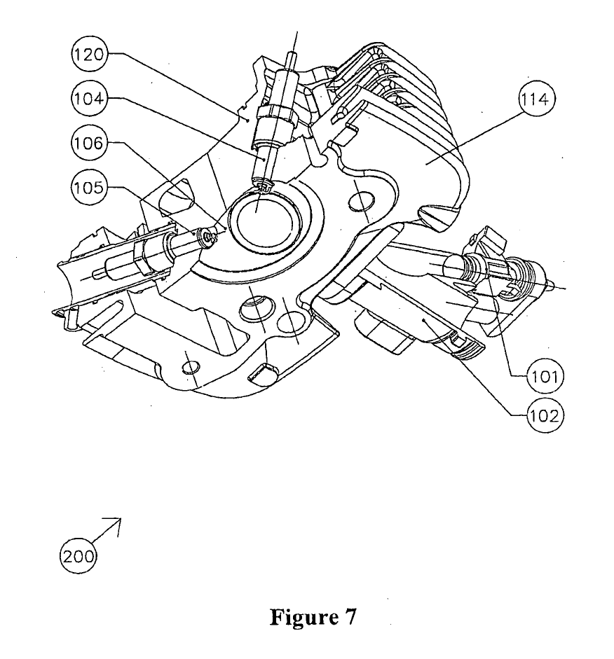

FIG. 7 is a schematic sectional view of an engine cylinder head for a dual ignition means fuel injected engine.

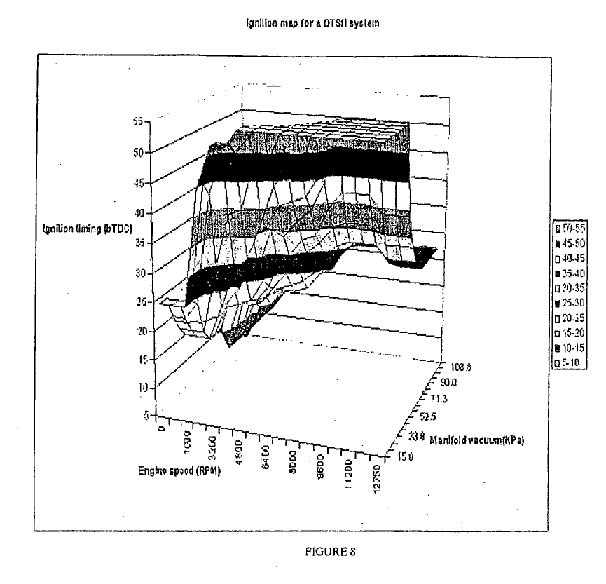

FIG. 8 illustrates an ignition timing map for the engine of FIG. 7.

Referring now to FIG. 1, there is shown the cylinder head 14 of a small bore internal combustion engine 100. The engine 100 works on the four stroke principle. Typical characteristics of such a small bore engine include a swept cylinder volume ranging from 70 cc to 200 cc and cylinder bore diameter 45 mm to 70 mm, employed as prime movers for operation of two or three wheeled vehicles or other motorized vehicles, for example as here, motorcycles.

Cylinder head 14 defines the top of a combustion chamber 120, of pent roof construction, and is. fitted with two spark plugs 15 and 16, of conventional manufacture, allowing the engine 100 to operate in a lean combustion mode to improve fuel economy.

Spark plugs 15 and 16 form part of a capacitive discharge ignition system (CDI system) 7. The CDI system 7 is schematically shown in FIG. 4 and comprises of a wave shaping means 3, a sensing means or a micro-controller control unit 4, a charging coil 5, a power supply rectification means 6, an ignition capacitor charging and trigger circuit A 8, and an ignition capacitor charging and trigger circuit B 9. CDI system 7 controls the manner and timing of firing of spark plugs 15 and 16 through the micro-controller control unit 4.

Magneto rotor 1 generates pulses in the pick up coil 2 which are input to micro-controller 4 through wave shaping means 3. The power supply to micro-controller 4 is provided by conventional charging coil 5 through power supply rectification means 6. Two outputs of the said micro-controller 4 are connected to the ignition capacitor charging and trigger circuit A 8 and ignition capacitor charging and trigger circuit B 9. The ignition capacitor charging trigger-circuit A 8 is connected to the spark plug 15 through ignition coil A 10 and the ignition capacitor charging and trigger circuit B 9 is connected to the spark plug 16 through ignition coil B 11. The vehicle fitted with this system can also be fitted with a throttle position sensor 12. Sensor 12 may be of a construction identifying the two states of wide open throttle and part open throttle. A sensor providing more detailed data for throttle position could also be employed.

When a rider of the motorcycle increases the speed of the vehicle by operating the throttle, the rate of rise of combustion pressure, a strongly combustion noise associated parameter, is sensed by micro-controller 4 through pick up coil 2. In addition, the rate of increase of engine speed may be input to micro-controller 4. In the preferred embodiment, it is these two combustion noise associated parameters, one primary and one. secondary, that are used in a strategy to control combustion noise to acceptable levels. These acceptable levels can be set and tested in a factory environment. Further parameters, such as manifold vacuum or pressure, may also be input to the control strategy.

Under low engine speed conditions, illustratively under 1600 rpm, both spark plugs 15 and 16 will be fired, on instruction of the micro-controller 4, to promote ignition of a lean fuel-air mixture charge delivered to engine 100, The micro-controller 4 is programmed with maps of the required ignition timings as a function of engine speed and rate of rise of combustion pressure.

At a threshold engine speed, illustratively above 1600 rpm, and a measured rate of rise of combustion pressure above a threshold value, say 3.5 bar per degree crank rotation, micro-controller 4 retards or discontinues firing of one of the spark plugs 16 by a predetermined value. Such control is implemented, in the illustrated embodiment, by a step wise maneuver, the step value or degree of retardation being dependent on measured engine speed. That is, over a mid speed range of say 1600 rpm to 5000 rpm, the degree of retardation will vary dependent on engine speed value. The degree of retardation may also vary with measured rate of rise of combustion pressure. The ignition timing of other spark plug 15 remains unchanged.

When the engine speed increases beyond certain value, say 5000 rpm, to the high speed range, particularly on wide open throttle acceleration conditions, where a rich air fuel ratio range fuel charge is delivered to combustion chamber 14, firing of the spark plug (16) is discontinued as unnecessary and the engine 100 runs only with one spark plug energized.

Exemplary maps of spark plug firing timing vs engine speed or ignition timing curves according to which noise and harshness control is implemented in accordance with the invention as above described is shown in FIG. 2. FIG. 2 illustrates ignition timing curves for the engine 100 having two spark plugs 15 and 16 per cylinder for the control strategy of the present invention wherein x-axis shows the engine speed (RPM) and Y-axis shows the ignition timing. When engine speed increases rapidly, ignition firing timing of one of the spark plug 16 retards by a predetermined value as indicated by D keeping ignition timing of spark plug 15 unchanged as indicated by C in the figure. This achieves noise and harshness reduction.

In contrast, FIG. 3 illustrates ignition timing curves for engines according to the prior art wherein the x-axis shows the engine speed (RPM) and the y-axis shows the ignition timing in degrees before Top Dead Center. As the engine speed increases, the ignition timing also varies and is applicable for both spark plugs, which are energized simultaneously. This simultaneous operation of spark plugs results in an over-promotion of combustion and potentially excessive noise and harshness. No control strategy for the ignition means to reduce such noise levels is provided.

Comparison of FIGS. 2 and 3 demonstrates that, using the ignition control strategy of the present invention under mid and high speed conditions, the progress of ignition and combustion may be controlled with consequential benefits in terms of noise and harshness reduction. Controlled retardation or discontinued spark plug operation when engine operating conditions in terms of measured or computed combustion noise associated parameters dictate, results in less noise since simultaneous firing of spark plugs 15 and 16 is not needlessly implemented.

The degree of control in terms of degree of retardation, ignition timings, conditions under which firing of a spark plug is discontinued and spark plug firing offset timings are dependent on whether the engine 100 is operated in part open throttle mode or wide open throttle mode and the engine speed. Flowcharts corresponding with control algorithms for the two throttle position modes are presented in FIGS. 5 and 6.

In such manner, the benefits of a dual spark plug ignition system for combustion of lean air-fuel mixtures may be maintained without the noise and harshness cost or disadvantage of dual ignition when rich air-fuel ratio fuel charges are required to be delivered to engine 100. Further benefits may also accrue insofar as spark plugs 15 and 16 would be expected to wear at a slower rate as firing timings are optimized to the engine operating conditions.

However, as the rider completes an acceleration phase by maintaining constant throttle position, as sensed by pick up coil 2, simultaneous ignition timing of both spark plugs 15 and 16 is restored being advantageous to good engine combustion performance.

The mapped values of the rate of increase of the engine speed during acceleration phase, variation in ignition timing required to be made for one spark plug and to which of the two spark plugs this is to be applied and the engine speed at which the cut-off of one of the spark plugs takes place depend upon engine design. Engine design parameters such as cylinder swept volume, engine maximum power and maximum torque and at which engine speed these occur, maximum speed of the vehicle; transmission gear ratios, dynamic rolling radius of tyres etc. affect such decisions. The maps will be programmed having regard to these parameters.

The above description relates to a system wherein the input of the engine speed has been taken from the said pulser coil, based on which the micro-controller 4 controls the ignition timing of one of the two spark plugs. The inputs can also be taken based on parameters such as manifold vacuum pressure (FIG. 8), instantaneous throttle position sensor or other parameters which can indicate or lead to indication of higher rate of combustion pressure and thus greater noise and harshness. When it is required to account for the load on the engine also, it is necessary to take the input from locations such as the manifold vacuum and/or the throttle position sensor. Such variations in the inputs taken are well within the scope of this invention.

Modifications and variations to the method and ignition control system of the present invention may be apparent to the skilled reader of this disclosure. Such modifications and variations are deemed within the scope of the present invention.

For example, the method and control system may be advantageously applied to a fuel injected engine as shown in FIG. 7. Here the cylinder head 114 of engine 200 defines the top of a combustion chamber 120 being fitted with two spark plugs 104 and 105, of conventional manufacture, allowing the engine 200 to operate in a lean combustion mode to improve fuel economy.

Engine 200 is a manifold fuel injected engine in which a manifold fuel injector 101 delivers a fuel charge to air manifold 102 delivering air to the engine combustion chamber 120. Combustion noise control is achieved using the same general strategy as above described.

Specifically, during constant speed running, depending on the manifold pressure and engine speed, an electronic engine control unit (ECU, not shown) triggers ignition sparking at required timing for both spark plugs 104 and 105. Such timings may be simultaneous or different, for example firing in some timing relationship which may be a fixed timing relationship.

During acceleration, firing of second spark plug 105 is retarded with respect to the first spark plug 104 by a crank angle functionally dependent on the engine speed. Acceleration may be sensed in two ways. For example, acceleration may be sensed if (1) the rate of change of throttle position sensor position exceeds a threshold value; or (2) the rate of change of engine speed is more than a threshold value. The ECU retards the spark timing of the second spark plug 105 if one of these two conditions is met. The spark timing of the second spark plug 105 is restored once the rate of change of engine speed is less than the threshold value.

The ignition timings are controlled in accordance with an ignition map, presented as FIG. 8, which sets ignition timing as a function of engine speed and manifold vacuum or pressure.

1-22. (canceled)

23. A method of controlling noise and harshness caused by combustion in a spark ignited engine during acceleration or high speed operation, the engine having a combustion chamber; a fuel delivery means for delivering a fuel charge to the combustion chamber; a plurality of spark ignition means located in the combustion chamber for igniting said fuel charge; and a control unit for retarding firing timing of at least one spark ignition means relative to firing timing of another spark ignition means to control noise and harshness wherein said control unit determines that firing timing of said at least one spark ignition means is to be retarded independent of manifold pressure; and in response to at least one of engine speed and determined rate of change of engine speed, for a determined range of sensed engine speeds, exceeding a threshold value.

24. The method of claim 23 wherein the engine speed is a high engine speed.

25. The method of claim 23 wherein the rate of change of engine speed threshold value is a high rate of change of engine speed value.

26. The method of claim 23 wherein rate of change of engine speed is determined on the basis of throttle position or fuel delivery per combustion cycle and variation in these.

27. The method of claim 25 wherein rate of change of engine speed of the engine is determined on the basis of the value of at least two of engine speed, throttle position, or fuel delivery per combustion cycle and variation in these values.

28. The method of claim 23 wherein the degree of retardation of firing timing of said at least one spark ignition means is determined as a function of throttle position.

29. The method of claim 28 wherein said throttle position is selected from a part open throttle position and a wide open throttle position.

30. The method of claim 23 wherein operation of at least one ignition means is retarded if determined rate of rise of combustion pressure exceeds a threshold value.

31. The method of claim 23 wherein operation of said at least one ignition means is retarded in a step change.

32. The method of claim 23 wherein a smooth transition from one ignition means firing timing to a retarded firing timing is effected by the control unit.

33. The method of claim 23 wherein firing of an ignition means is discontinued if engine speed or rate of change of engine speed exceeds a threshold value.

34. The method of claim 23 wherein the engine is injected with said fuel charge.

35. The method of claim 23 wherein the manifold of the engine is injected with fuel.

36. The method of claim 23 wherein air fuel ratio of the fuel charge is in a lean range.

37. The method of claim 23 wherein the engine is operated in lean combustion mode.

38. The method of claim 37 wherein the engine is a single cylinder engine having a swept cylinder volume of between 70 cc and 200 cc.

39. The method of claim 23 when implemented in a small bore engine.

40. An ignition control system for an engine comprising:
a plurality of spark ignition means (15, 16); and
a control unit (4) for retarding firing timing of at least one spark ignition means (15, 16) relative to firing timing of another spark ignition means (15, 16) to control noise and harshness wherein said control unit (4) is programmed to receive engine speed or rate of change of engine speed data and to determine that firing timing of said at least one ignition means (15, 16) is to be retarded in accordance with said data, and independently of manifold pressure to control noise and harshness when engine speed or rate of change of engine speed, for a determined range of sensed engine speeds, exceeds a threshold value.

41. The ignition control system of claim 40 wherein the control unit is programmed with maps providing degree of retardation of ignition firing timing as a function of at least one parameter selected from the group consisting of engine speed, throttle position, and fuelling rate and variation in these.

42. The ignition control system of claim 40 wherein the maps are provided for part open throttle and wide open throttle engine operating conditions.

43. The ignition control system of any one of claims 40 wherein the maps are provided as a function of throttle position.

44. The ignition control system of claim 40 wherein degree of retardation of firing timing of said at least one spark ignition means is determined as a function of throttle position.
